(19) United States
(12) Patent Application Publication
(10) Pub. No.: US 2007/0017472 A1
(43) Pub. Date: Jan. 25, 2007

(54) Active intake and induction system

(75) Inventors: Mark Letourneau, Dover Centre (CA); Jason Pettipiece, Chatham (CA)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Inc., Chatham (CA)

(21) Appl. No.: 11/185,597

(22) Filed: Jul. 20, 2005

(51) Int. Cl. F02M 35/10

(52) U.S. Cl. 123/184.53

(57) ABSTRACT

An air inlet is mounted adjacent to an actuator and an intake manifold. A valve shaft extending from the actuator to the air inlet rotates the inlet valve from an open position to a closed position, or vice versa. The actuator senses revolutions per minute of an engine to control the inlet valve position. When the inlet valve is in the closed position the amount of oxygen reaching the engine is reduced. The restricted airflow through the air inlet helps to reduce engine noise.

### BACKGROUND OF THE INVENTION

The invention is an arrangement for controlling airflow within a secondary air inlet in intake manifolds.

Intake manifolds control the amount of air entering internal combustion engines. Air enters the intake manifold and flows through to the engine. Intake manifolds use shaft and blade assemblies to control the intake of air into the manifold assembly from a main air inlet. A manifold housing usually has a secondary air inlet, which leads to an air cleaner.

At lower engine revolutions per minute (RPM) less air is needed within the engine. Maximum airflow through the main air inlet and secondary air inlet is not required. Noise created by the intake manifold is undesirable. However, at higher engine RPM more oxygen is needed to support engine performance. Airflow into the intake manifold must be increased to obtain the desired amount of oxygen within the engine.

An arrangement for reducing air inflow into an intake manifold at low engine RPMs to reduce noise during engine operation is needed.

### SUMMARY OF THE INVENTION

An actuator is mounted to an intake manifold assembly. A secondary air inlet is mounted adjacent to the actuator and the intake manifold assembly. Extending from the actuator is a valve shaft. The valve shaft extends into the secondary air inlet. Bearings provide support while allowing the valve shaft to freely rotate. An inlet valve is located within the secondary air inlet and supported by the valve shaft.

During operation of the engine the actuator senses the revolutions per minute (RPM) of the engine. The actuator rotates the valve shaft in response to the engine RPM. As the valve shaft rotates the inlet valve is moved between an open position and a closed position.

When the inlet valve is in the open position air can flow freely through the air inlet and into the air cleaner. When the engine RPMs drop below a predetermined limit, the inlet valve is moved toward the closed position. When the inlet valve is in the closed position airflow is restricted. The amount of oxygen reaching the engine is reduced. The restricted airflow through the air inlet helps to reduce engine noise when the engine is operating at lower RPMs.

As the RPMs of the engine increase the actuator senses the change. The valve shaft and inlet valve move from the closed position to the open position to allow unrestricted airflow to the air cleaner. Thus, the engine is provided with more oxygen allowing more efficient performance to occur.

These and other features of the present invention can be best understood from the following specification and drawings, the following of which is a brief description.

### BRIEF DESCRIPTION OF THE DRAWINGS

FIG. 1 shows an perspective view of an intake manifold assembly with an actuator and secondary air inlet of the present invention;

FIG. 1A shows a schematic of the primary and secondary air flow;

FIG. 2 is an end view of the secondary air inlet and inlet valve;

FIG. 3A is a cross section through A-A of the secondary air inlet showing the inlet valve is an open position; and

FIG. 3B is a cross section through A-A of the air inlet showing the inlet valve in a closed position.

### DETAILED DESCRIPTION OF THE PREFERRED EMBODIMENT

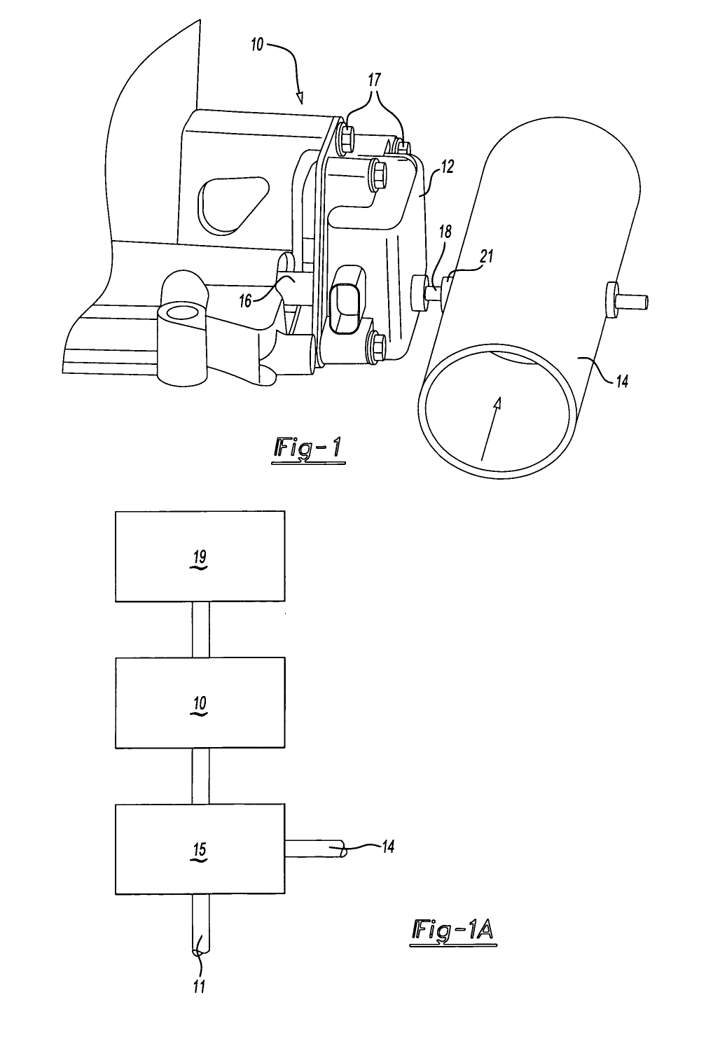

FIG. 1 shows an intake manifold assembly 10, an actuator 12, and a secondary air inlet 14. The actuator 12 is mounted to the intake manifold assembly 10 using fasteners 17. The air inlet 14 is mounted adjacent to the actuator 12 and the intake manifold assembly 10. The air inlet 14 leads to and is supported by an air cleaner housing 15.

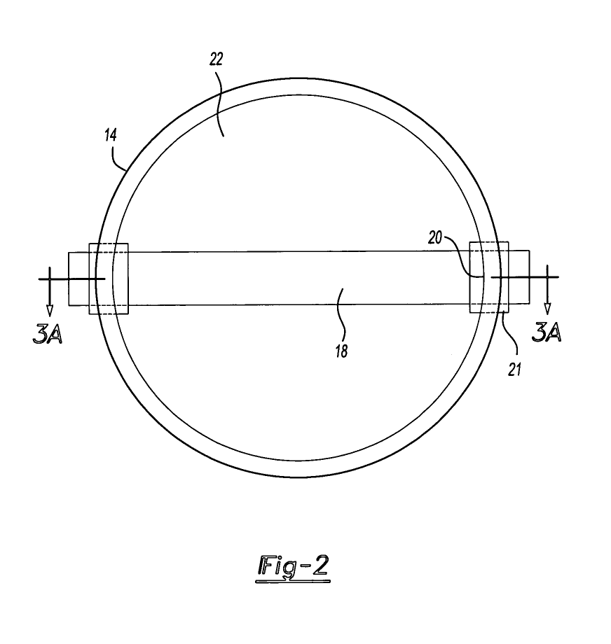

Extending from the actuator 12 in a first direction is a main shaft 16. The actuator controls the main shaft 16 to open or close the main air inlet of the intake manifold assembly 10. A valve shaft 18 extends from an opposing side of the actuator 12. The valve shaft 18 extends into the air inlet 14 through openings 20 (shown in FIG. 2). Bearings 21 located at the openings 20 provide support for the valve shaft 18 while supporting the valve shaft 18 for rotation.

Referring to FIG. 1A passage of air from the secondary air inlet 14 to the engine 15 is shown schematically. Air enters the air inlet 14 and flows through the air inlet 14 to an air cleaner within the air cleaner housing 15. From the air cleaner housing 15 the airflow continues through the intake manifold assembly 10 to the engine 19. The primary air flow is also shown schematically. The primary airflow enters the air cleaner housing 15 through passage 11 and continues through to the intake manifold assembly 10 and directly into the engine 19.

Referring to FIG. 2, an inlet valve 22 is located within the air inlet 14 and supported by the valve shaft 18. The inlet valve 22 has a similar shape as the cross-section of the air inlet 14. In the embodiment the inlet valve 22 has a circular shape to correspond to the circular cross section of the air inlet 14. The air inlet 14 and inlet valve 22 may take other shapes according to the desired configuration.

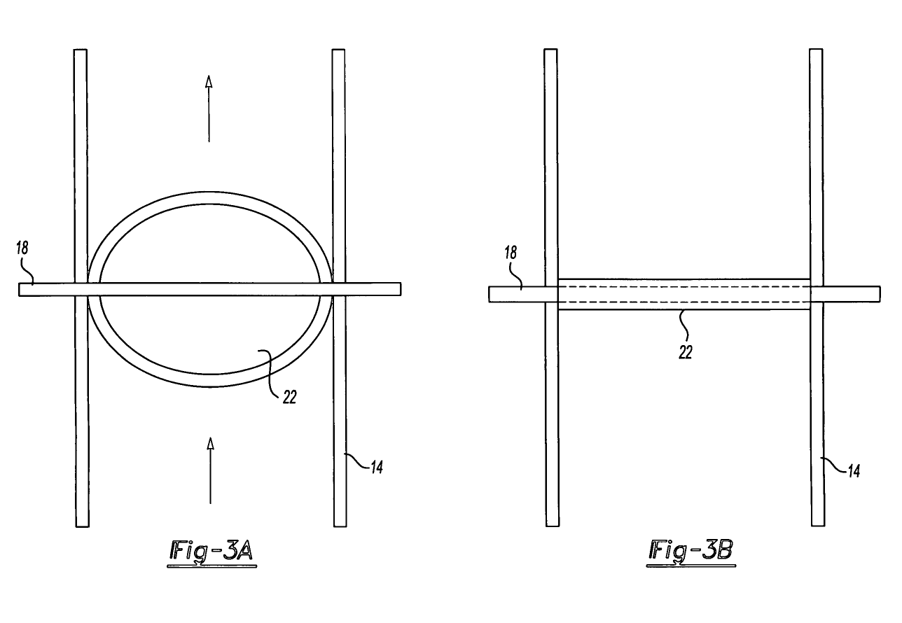

During operation of the engine the actuator 12 sense the revolutions per minute (RPM) of the engine. When the engine RPMs have reduced to a predetermined limit the actuator 12 rotates the valve shaft 18 from an open position to a closed position. Correspondingly, as the valve shaft 18 rotates the inlet valve 22 is moved from an open position (shown in FIG. 3a) to a closed position (shown in FIG. 3b). When the inlet valve 22 is in the open position air can flow freely through the air inlet 14 and into the air cleaner. When the inlet valve 22 is in the closed position airflow is restricted. Minimal air passes through the air inlet 14 into the air cleaner. Thus, the amount of oxygen reaching the engine is reduced. The restricted airflow through the air inlet 14 helps to reduce engine noise when the engine is operating at lower RPMs.

As the RPMs of the engine increase the actuator 12 senses the change. When the RPMs have reached a predetermined level the actuator 12 activates the valve shaft 18 to rotate. The valve shaft 18 moves from the closed position to the open position. Correspondingly, the inlet valve 22 moves from the closed position to the open position. The open position of the inlet valve 22 allows unrestricted airflow to the air cleaner. Thus, the engine is provided with more oxygen allowing more efficient performance to occur. Preferably, the actuator 12 operates to open and close the secondary air inlet 14 at the same time as the main air inlet is opened and closed.

The embodiment above discuses the actuator 12 moving the inlet valve 22 from open to closed position, and vice versa, at a predetermined engine RPM. The actuator 12 may also partially rotate the valve shaft over a range of engine RPMs. For example, the inlet valve 22 is in an open position and the actuator 12 senses a lowering of the RPMs. As the engine RPMs change the actuator 12 rotates the valve shaft 18 and the inlet valve 22 to a partially closed position. The further the engine RPMs lower the more the inlet valve 22 is rotated to the closed position, until the inlet valve 22 is placed in a closed position. The inlet valve 22 would remain closed as engine RPMs continued to lower or remained low.

As engine RPMs beginning to raise the actuator 12 senses this and the inlet valve 22 is gradually rotated until a fully opened position is reached. The inlet valve 22 would remain open as engine RPMs continue to raise or remain high. Because the actuator acts over a range of RPMs the inlet valve 22 may be positioned in a partially open/closed position if engine RPMs remain at a moderate level.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An intake manifold assembly comprising:
a primary air inlet and a secondary air inlet associated with an intake manifold housing;
an inlet valve located within said secondary air inlet; and
an actuator controllably connected to the inlet valve.

2. The intake manifold shaft assembly of claim 1, wherein said actuator is connected to a main shaft within said intake manifold housing.

3. The intake manifold assembly of claim 1, wherein said inlet valve is mounted for rotation on a valve shaft located within said secondary air inlet.

4. The intake manifold assembly of claim 3, wherein said valve shaft is connected to said actuator.

5. The intake manifold assembly of claim 1, wherein said inlet valve is moved towards a closed position at lower engine revolutions per minute and towards an open position at higher engine revolutions per minute.

6. A method of controlling airflow in an intake manifold assembly comprising:
a) providing a primary and secondary air inlet associated each associated with an intake manifold housing;
b) positioning an inlet valve located within said secondary air inlet; and
c) controlling the position of the inlet valve with an actuator.

7. The method of claim 7, wherein said step c) includes the actuator closing the secondary air inlet when revolutions per minute of an engine are below a predetermined level.

8. The method of claim 7, wherein said step b) includes mounting the inlet valve on a valve shaft located within the secondary air inlet.

9. The method of claim 6, wherein said step c) includes rotating a valve shaft to move the inlet valve between an open or closed position.

10. The method of claim 9, wherein said step c) includes rotating the valve shaft along with a main shaft.
